(19) United States
(12) Patent Application Publication
(10) Pub. No.: US 2016/0014446 A1
(43) Pub. Date: Jan. 14, 2016

(54) TOUCH-SCREEN REMOTE CONTROLLER AND REMOTE CONTROL METHOD THEREOF

(71) Applicant: BOE TECHNOLOGY GROUP CO., LTD., Beijing (CN)

(72) Inventors: Wenbo LI, Beijing (CN); Xiangyan ZHANG, Beijing (CN)

(21) Appl. No.: 14/429,149

(22) PCT Filed: Jul. 30, 2014
(86) PCT No.: PCT/CN2014/083310

§ 371 Date: Mar. 18, 2015

(30) Foreign Application Priority Data
Dec. 4, 2013 (CN) 201310646065.9

(51) Int. Cl. H04N 21/422; H04N 5/44; H04N 21/433; G06F 3/01; H04N 21/482; H04N 21/41; G06K 9/00

(52) U.S. Cl. CPC H04N 21/42224; H04N 21/4126; H04N 21/42222; H04N 5/4403; G06K 9/00597; H04N 21/42221; G06F 3/013; H04N 21/4821; H04N 21/4332; H04N 2005/443; H04N 2005/4426; H04N 2005/441

(57) ABSTRACT

The present invention provides a touch-screen remote controller and a remote control method thereof, relates to the field of remote control technology, and can solve the problem of limited functions of the existing touch-screen remote controller. The touch-screen remote controller of the present invention comprises a microprocessor module, a touch-control module, a power supply module, a storage module and a program classification module, wherein, the power supply module provides power for the microprocessor module, the touch-control module achieves a touch-control function under the control of the microprocessor module, the storage module stores TV listings therein and is connected with the microprocessor module, and the program classification module is used for classifying TV programs contained in the TV listings stored in the storage module under the control of the microprocessor module.

### FIELD OF THE INVENTION

The present invention relates to the field of remote control technology, and particularly relates to a touch-screen remote controller and a remote control method thereof.

### BACKGROUND OF THE INVENTION

Remote controller, as an ancillary product of a television, greatly facilitates a user to manipulate the television. A conventional remote controller generally takes a form of physical keyboard, and the user can control the television by manipulating physical buttons. However, buttons on some remote controllers become insensitive, and in many cases, multiple pressing operations are needed to manipulate the television, after the remote controllers are used for a period of time. In addition, with the development of smart television, functions of a television are increasing, accordingly, the number of buttons on a remote controller is increasing, and volume of the remote controller is also getting larger. Apparently, the form of physical keyboard is no longer applicable.

In order to facilitate use's operation, a touch-screen remote controller has been proposed in the prior art, which manipulates a remote controller by means of touch control. In this case, the user can control the television by clicking on the interface of the touch-screen remote controller. Meanwhile, the touch-screen remote controller may further adopt multi-screen interactive technique to display corresponding video images in synchronization with the television. The multi-screen interactive technique refers to technique in which based on DLNA (Digital Living Network Alliance, a interconnection technique between wireless network and wired network) protocol, IGRS protocol, Miracast (Miracast devices provide simplified discovery and setup, and users can quickly transmit videos between devices) protocol or the like, a series of operations, such as transmission, analysis, demonstration and control, can be performed on multimedia contents (including audio files, videos, images or the like) on different multimedia terminals, via Wi-Fi (Wireless-Fidelity) network connection, and shown contents can be shared simultaneously on devices with different platforms, which enriches user's multimedia life. Simply put, screens of several devices can be interconnected through a dedicated connection device, so as to realize resource sharing. For example, movies in a mobile phone can be played on a television, images in a tablet computer can be shared with a television, and contents stored in a computer can be projected on a television. This is an advanced technique which is quietly arising at present.

Although the multi-screen interaction can be realized between the touch-screen remote controller provided in the prior art and a television, users expect that the remote controller, as a handheld device, can provide more and richer functions. However, the existing touch-screen remote controller has simple function, which cannot meet users' further demand and is lack of entertainment.

### SUMMARY OF THE INVENTION

The technical problem to be solved by the present invention includes providing a multi-functional and easy-to-use touch-screen remote controller and a remote control method thereof, in view of the problem of limited functions of the existing touch-screen remote controller.

As a technical solution adopted to solve the technical problem of the present invention, a touch-screen remote controller is provided, comprising a microprocessor module, a touch-control module, a power supply module, a storage module and a program classification module, wherein, the power supply module provides power for the microprocessor module, the touch-control module achieves a touch-control function under the control of the microprocessor module, the storage module stores TV listings therein and is connected with the microprocessor module, and the program classification module is used for classifying TV programs contained in the TV listings stored in the storage module under the control of the microprocessor module.

The program classification module of the touch-screen remote controller of the present invention classifies the TV programs contained in the TV listings stored in the storage module into types such as news, entertainment, legal system, movie, TV play and the like, by means of analysis and processing of the microprocessor module, so that users can select the TV programs more conveniently, and manipulate the remote controller more directly.

Preferably, the program classification module classifies programs broadcast on respective channels according to time period and program content.

Preferably, the touch-screen remote controller further comprises a program type selecting module used for selecting a program type to be displayed from program types classified by the program classification module, and a program selecting module used for selecting one channel from channels belonging to the program type selected by the program type selecting module to display a program of the one channel.

Preferably, the touch-screen remote controller further comprises an eye tracking module which is respectively connected to the touch-control module and the microprocessor module and is used for determining position coordinates of a fixation point of a user's eyes on a touch screen and implementing selection commands by means of processing of the microprocessor module.

Preferably, the touch-screen remote controller further comprises a charge management module which is connected with the power supply module and is used for charging the power supply module.

Preferably, a USB interface and/or a solar energy receiving module is provided on the charge management module, and the charge management module charges the power supply module via the USB interface, and/or charges the power supply module with solar energy through the solar energy receiving module.

Preferably, the touch-screen remote controller further comprises an infrared emitting module which is used for transmitting selection signals processed by the microprocessor module to a television to achieve display.

Preferably, the touch-screen remote controller further comprises an illumination module connected with the power supply module.

Preferably, a touch screen of the touch-screen remote controller is a liquid crystal screen.

Preferably, the touch-screen remote controller further comprises a remote controller power switch button connected to the microprocessor module, wherein

when a duration for which the remote controller power switch button is pressed is less than 2 seconds, the microprocessor module controls a touch screen of the touch-screen remote controller to be locked; and

when a duration for which the remote controller power switch button is pressed is no less than 2 seconds, the microprocessor module controls the power supply module of the touch-screen remote controller to be turned off or turned on.

Preferably, the touch-screen remote controller further comprises a reset button connected to the microprocessor module, wherein

when a television is in an off-state, by holding the reset button down and clicking the remote controller power switch button, the touch screen displays a calendar and/or temperature and/or humidity; and by holding the reset button down and double-clicking the remote controller power switch button, the touch screen displays an electronic album.

Preferably, the touch-screen remote controller is capable of displaying synchronously with a television based on a multi-screen interactive technique.

As a technical solution adopted to solve the technical problem of the present invention, a remote control method using a touch-screen remote controller is provided, the touch-screen remote controller is the above touch-screen remote controller, and the method comprises the following step of:

classifying, by controlling the program classification module of the touch-screen remote controller through the microprocessor module, TV programs contained in the TV listings stored in the storage module.

Preferably, the step of classifying TV programs specifically comprises: with respect to the TV listings stored in the storage module, classifying, by controlling the program classification module of the touch-screen remote controller through the microprocessor module, programs broadcast on respective channels according to time period and program content.

Preferably, the touch-screen remote controller further comprises a program type selecting module and a program selecting module, the remote control method using the touch-screen remote controller further comprises the following steps of:

a program type selecting step of selecting, by using the program type selecting module, a program type to be displayed from program types classified by the program classification module; and

a program selecting step of selecting, by using the program selecting module, one channel from channels belonging to the program type selected by the program type selecting module to display a program of the one channel.

Preferably, the touch-screen remote controller further comprises an eye tracking module, and the program type selecting step specifically comprises:

determining, by the eye tracking module, position coordinates of a fixation point of a user's eyes on a touch screen; and

controlling, by the microprocessor module, the program type selecting module to execute a command of selecting a program type, according to the position coordinates of the fixation point of the user's eyes on the touch screen;

the program selecting step specifically comprises:

determining, by the eye tracking module, position coordinates of a fixation point of the user's eyes on the touch screen; and

controlling, by the microprocessor module, the program selecting module to execute a command of selecting a channel, according to the position coordinates of the fixation point of the user's eyes on the touch screen.

### BRIEF DESCRIPTION OF THE DRAWINGS

FIG. 1 is block diagram of a structure of a touch-screen remote controller according to Embodiment 1 of the present invention;

FIGS. 2 to 5 are schematic diagrams illustrating the front, the back and the side of the touch-screen remote controller according to Embodiment 1 of the present invention, respectively;

FIG. 6 is a schematic diagram illustrating program classification of the touch-screen remote controller according to Embodiments 1 and 2 of the present invention;

FIG. 7 is a schematic diagram illustrating program selection of the touch-screen remote controller according to Embodiments 1 and 2 of the present invention;

FIG. 8 is a flow chart of a remote control method of a touch-screen remote controller according to Embodiment 2 of the present invention; and

FIG. 9 is a specific flow chart of an eye tracking process in the remote control method of a touch-screen remote controller according to Embodiment 2 of the present invention.

### DETAILED DESCRIPTION OF THE EMBODIMENTS

To enable those skilled in the art to better understand the technical solutions of the present invention, the present invention will be further described in detail below in conjunction with the accompanying drawings and specific implementations.

### Embodiment 1

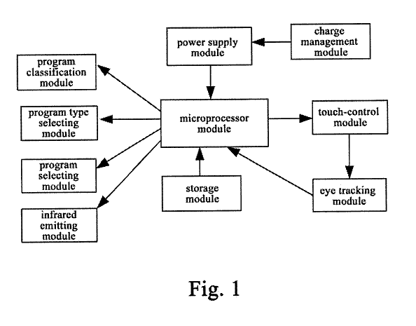

The present embodiment provides a touch-screen remote controller which, as shown in FIG. 1, comprises: a microprocessor module, a touch-control module, a power supply module, a storage module and a program classification module. The power supply module provides power for the microprocessor module, the touch-control module achieves a touch-control function under the control of the microprocessor module, the storage module stores TV listings therein and is connected with the microprocessor module, and the program classification module is used for classifying TV programs contained in the TV listings stored in the storage module under the control of the microprocessor module.

The program classification module in the touch-screen remote controller provided by the present embodiment classifies the TV programs stored in the storage module into types such as news, entertainment, legal system, movie, TV play and the like, according to results of analysis and processing of the microprocessor module, so that users can select the TV programs more conveniently, and manipulate the remote controller more directly.

Preferably, the program classification module classifies the programs broadcast on respective channels according to time period and program content. Specifically, in different time periods, type of the program broadcast on each channel is smartly-updated regularly according to the program content broadcast on the channel. Taking CCTV-1 comprehensive channel as an example, this channel broadcasts news from 12:00 to 12:30 and from 19:00 to 19:30, and thus in these two time periods, the type of the program broadcast on this channel is set to be news; “legal report” is broadcast from 12:35 to 12:55, and thus in this time period, type of the program is set to be legal system; TV plays are broadcast in prime times at afternoon and evening, and thus in these two time periods, type of the program is set to be TV play. With the program classification module, programs broadcast on the respective channels can be retrieved and classified regularly, so as to smartly update types of the programs on the respective channels.

After the TV programs broadcast on the respective channels are regularly classified by the program classification module, users can directly select a desired channel, without the need to identify a desired TV channel from numerous TV channels one by one, thus further facilitating users to select the TV programs.

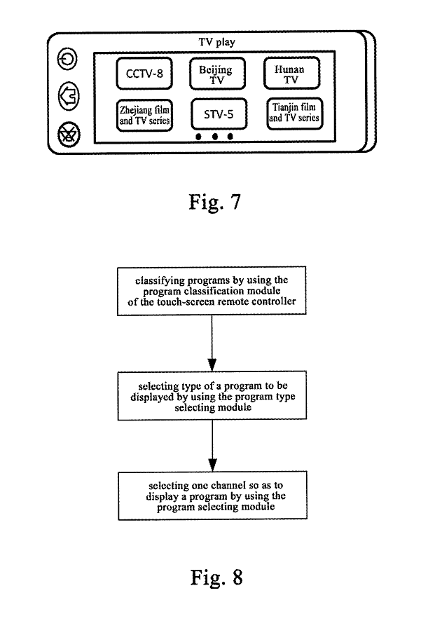

In order to facilitate users to select different programs, preferably, the touch-screen remote controller of the present embodiment further comprises a program type selecting module used for selecting a program type to be displayed from the program types (as shown in FIG. 6) classified by the program classification module, and a program selecting module used for selecting a channel from the channels (as shown in FIG. 7) belonging to the program type selected by the program type selecting module to display the program of the channel. In other words, after program classification is completed, the program type selecting module picks out the channels corresponding to the program type specified by the user, and the program selecting module selects one specific channel specified by the user from the channels picked out by the program type selecting module and outputs a channel selection signal to finally display the program on the channel.

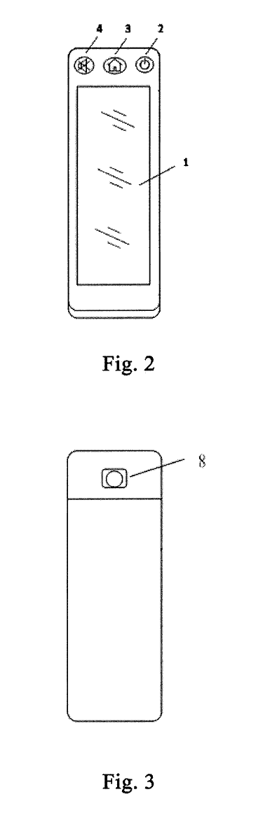

Preferably, the touch-control module in the touch-screen remote controller of the present embodiment comprises a touch-screen touch-control circuit connected with the microprocessor module and a touch screen 1 (as shown in FIG. 2), and preferably, the touch screen 1 is a liquid crystal screen. Since the liquid crystal screen is provided with a backlight module, the touch-screen remote controller can be normally used even in a place with dark ambient light, thus solving the problem that the existing remote controller cannot be used in a place with dark ambient light. Needless to say, the touch screen 1 of the present invention is not limited to the liquid crystal screen, and for example, may be an OLED screen or the like.

Preferably, the touch-screen remote controller of the present embodiment further comprises an eye tracking module which is respectively connected to the touch-control module and the microprocessor module and is used for determining position coordinates of a fixation point of the user's eyes on the touch screen 1, and the microprocessor module implements commands such as a command of selecting a program type, a command of selecting a channel and the like according to the determined position coordinates. The eye tracking module comprises an eye tracking circuit, an eye movement determining circuit and an eye instrument driving module, and is used for tracking eyeballs and providing a tracking result and the like to the microprocessor module. In this case, the user can directly manipulate the touch-screen remote controller with eyes to control the television, without the need to control the touch-screen remote controller by hand. Such touch-screen remote controller provided with the eye tracking module is particularly suitable for a disabled user with hand impairment to use.

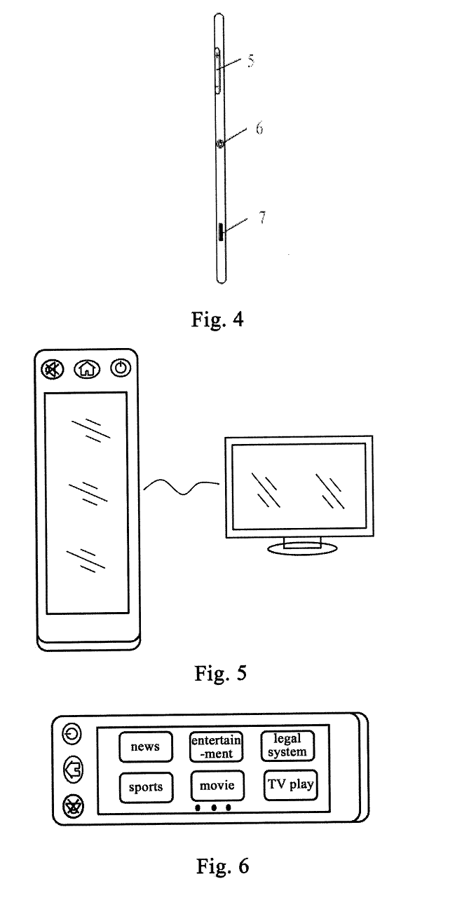

Preferably, the touch-screen remote controller of the present embodiment further comprises a charge management module which, as shown in FIG. 1, is connected with the power supply module, and is used for charging the power supply module. The charge management module comprises a charge management circuit connected to the power supply module, namely, the power supply module is a recyclable power supply. Further preferably, the charge management module charges the power supply module via a USB interface 7 (as shown in FIG. 4) provided thereon, and/or charges the power supply module with solar energy through a solar energy receiving module provided thereon. That is to say, the power supply module can be charged either via the USB interface 7 provided on the charge management module, or after the solar energy receiving module provided on the charge management module converts solar energy into electric energy, and needless to say, both preceding charging methods can be used simultaneously. It should be noted that, the USB interface 7 may also be used to transfer some data into the storage module.

Preferably, the touch-screen remote controller of the present embodiment further comprises an infrared emitting module which is used for transmitting various selection signals processed by the microprocessor module to the television, and the television perform corresponding display operation after an antenna thereof receives the selection signals, as shown in FIG. 5. The selection signals may include a channel selection signal, a program type selection signal and other display control signals. In a case that the selection signal is the channel selection signal, information regarding the TV channel selected by the user is transmitted to the television via the infrared emitting module after processed by the microprocessor, thus achieving display of the TV program of the corresponding channel. Specifically, the infrared emitting module comprises a signal transmitting control circuit and an infrared emitting diode connected thereto, the signal transmitting control circuit is controlled by the program classification module, the program type selecting module, program selecting module and the like, receives selection signals output from them, and then transmits the selection signals to the television via the infrared emitting diode.

Preferably, the touch-screen remote controller of the present embodiment further comprises an illumination module (not shown in FIG. 1) connected with the power supply module. The illumination module substantially achieves a function of a flashlight 8 (as shown in FIG. 3), and is generally provided on a back cover of the touch-screen remote controller. The illumination module may be turned on to achieve illumination function when ambient environment is dark.

Preferably, the touch-screen remote controller of the present embodiment further comprises a remote controller power switch button 6 (as shown in FIG. 4) connected to the microprocessor module. For example, when a duration for which the remote controller power switch button 6 is pressed is less than 2 seconds, the microprocessor module controls the touch screen 1 to be locked; and when a duration for which the remote controller power switch button 6 is pressed is no less than 2 seconds, the microprocessor module controls the power supply module to be turned off or turned on, so as to save the energy of the power supply module. Needless to say, the ways to lock the touch screen 1 and turn on or turn off the power supply module are not limited to the above, and may also be implemented by setting the microprocessor module. For example, the microprocessor module may be set such that when the remote controller power switch button 6 is clicked, the touch screen 1 is locked, and when the remote controller power switch button 6 is double-clicked, the power supply module is turned off or turned on. Locking the touch screen 1 can protect display content of the television from being unnecessarily impacted when the user swipes on the touch screen 1 unexpectedly, and turning off the power supply module facilitates saving electricity and avoiding energy waste.

To facilitate users' life, the touch-screen remote controller may be provided with auxiliary functions other than selection of TV programs. For example, further preferably, the touch-screen remote controller further comprises a reset button 3 (as shown in FIG. 2) connected to the microprocessor module. For example, when the television is in an off-state, by holding the reset button 3 down and clicking the remote controller power switch button 6, the touch screen 1 displays a calendar, and/or environment index such as temperature and/or humidity; and by holding the reset button down and double-clicking the remote controller power switch button 6, the touch screen 1 displays an electronic album. The principle thereof is similar to that of locking the touch screen 1 and turning on and turning off the power supply module, and are not repeatedly described here. It should be noted that, the reset button 3 is not limited to the forgoing functions, and the reset button 3 may also be used to realize an operation of returning to the previous step. For example, when the television is switched to another channel, pressing the reset button 3 may enable the television to return back to the previous channel.

Preferably, the touch-screen remote controller provided by the present embodiment may adopt the multi-screen interactive technique to display synchronously with the television. That is, touch screen 1 of the remote controller displays the same image as that on the television, thus further enriching the way and location of watching for users.

It should be noted that, all of the storage module, the program classification module, the program type selecting module and the program selecting module in the touch-screen remote controller may be integrated with the microprocessor module in one chip, or surely can be provided separately. The touch-screen remote controller may further comprise a volume adjusting unit 5 (as shown in FIG. 4) for adjusting volume of the television when a TV program is displayed; the touch-screen remote controller may further comprise a television power switch control button 2 (as shown in FIG. 2) for controlling on-state or off-state of the television, and a mute button 4 (as shown in FIG. 2) for controlling the television to be mute, etc. Undoubtedly, the touch-screen remote controller may further comprise other functional chips, so as to develop different functional modules according to needs of different users, and further enhance diversity in use of the touch-screen remote controller. For example, according to users' needs, emergency number or the like may be set inside the touch-screen remote controller, this is particularly suitable for the aged, and in a case that an emergency occurs when an old man is watching TV, the emergency number can be directly dialed through the touch-screen remote controller.

### Embodiment 2

As shown in FIG. 8, with respect to the above touch-screen remote controller, the present embodiment provides a remote control method using a touch-screen remote controller, which comprises the following three steps.

Step 1, classifying, by controlling the program classification module of the touch-screen remote controller through the microprocessor module, the TV programs contained in the TV listings stored in the storage module.

Preferably, step 1 may specifically comprise: with respect to the TV listings stored in the storage module, classifying, by controlling the program classification module of the touch-screen remote controller through the microprocessor module, programs broadcast on the respective channels according to time period and program content.

Step 2, a program type selecting step of selecting, by using the program type selecting module of the touch-screen remote controller, a program type to be displayed from program types classified by the program classification module.

Step 3, a program selecting step of selecting, by using the program selecting module of the touch-screen remote controller, a channel from channels belonging to the program type selected by the program type selecting module to display a program of the one channel.

The touch-screen remote controller further comprises an eye tracking module, and the program type selecting step (i.e., step 2) further comprises:

determining, by the eye tracking module, position coordinates of a fixation point of a user's eyes on the touch screen; and

controlling, by the microprocessor module, the program type selecting module to execute a command of selecting a program type, according to the position coordinates of the fixation point of the user's eyes on the touch screen.

The program selecting step (i.e., step 3) further comprises:

determining, by the eye tracking module, position coordinates of a fixation point of the user's eyes on the touch screen; and

controlling, by the microprocessor module, the program selecting module to execute a command of selecting a channel, according to the position coordinates of the fixation point of the user's eyes on the touch screen, thereby achieving the selection of a specified program.

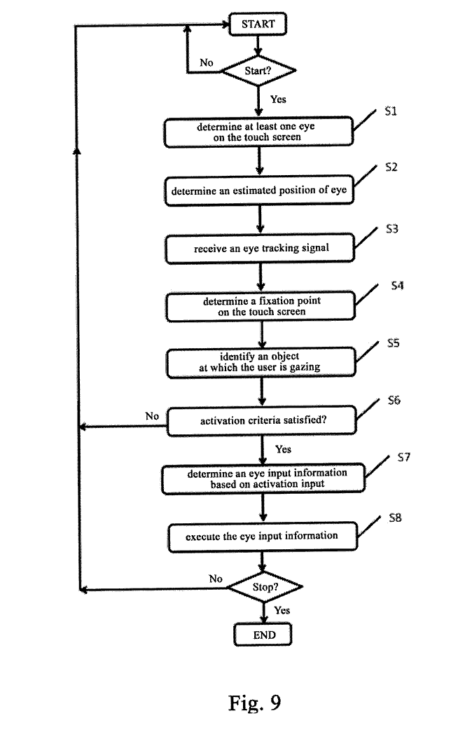

As shown in FIG. 9, specific working process of the eye tracking module comprises steps of:

S1, checking whether at least one eye of a user has been detected or not in consecutive image data of the touch-screen remote controller, if one or more eyes have been detected, proceeding to step S2, and if no eye is detected, continuing to check until an eye is detected;

S2, determining an estimated position of each of the at least one eye based on the consecutive image data in which the user's eye(s) has been detected and sending an eye tracking signal to the microprocessor module;

S3, receiving, by the microprocessor module, the eye tracking signal;

S4, using the eye tracking signal to determining coordinates of the fixation point of the user on the touch screen of the remote controller;

S5, using the determined coordinates of the fixation point to identify an object at which the user's eye(s) is gazing, to determine the object corresponding to the coordinates of the fixation point;

S6, checking whether an activation input information has been received on the touch screen of the remote controller from the user's eye(s);

S7, determining a specific channel selecting operation to be performed based on the received activation input information from the user's eye(s) and the identified gazing object; and

S8, sending a channel selecting instruction, and performing the determined channel selecting operation.

By using the remote control method of a touch-screen remote controller provided by the present embodiment to classify the TV programs, the user can manipulate the remote controller more conveniently, and the eye tracking module makes operation more intelligent, and particularly facilitates a disabled user to use.

It should be noted that, the remote control method of a touch-screen remote controller provided by the present embodiment is just part of the remote control method of a touch-screen remote controller, and the remote control method of a touch-screen remote controller may also comprise conventional operating methods of a remote controller. Specifically, the user operates the touch screen of the remote controller, a signal processing device converts data representing coordinates of the detected operation into a corresponding television operating command, the remote controller transmits the signal to the television via the infrared emitting diode, a signal receiving unit is provided in the television, and the television performs a corresponding operation based on the received signal data and updates video images thereof, thus completing control of the remote controller over the television.

When setting the interface of the remote controller, channel number buttons (0-9), channel number increasing/decreasing buttons, volume increasing/decreasing buttons, menu button, channel selecting button, favorite program button and the like may be set on the main page (i.e., home page), since these buttons are most commonly used. After such setting, there are fewer pictures distributed on the main page, which facilitates users to manipulate and use. Further, sound effect buttons, picture effect buttons, time setting buttons may be set in a sub-page (i.e., secondary page). The program classification module is built in the touch-screen remote controller of the present invention, and can classify the TV programs into news, entertainment, legal system, sports, movie, TV play, children's program, drama, lifestyle, travelling, shopping and the like, and smartly-update type of the program broadcast on each channel regularly according to the program content broadcast on the channel in different time periods. Taking CCTV-1 comprehensive channel as an example, this channel broadcasts news from 12:00 to 12:30 and from 19:00 to 19:30, and thus in these two time periods, type of the program broadcast on this channel is set to be news; “legal report” is broadcast from 12:35 to 12:55, and thus in this time period, type of the program is set to be legal system; TV plays are broadcast in prime times at afternoon and evening, and thus in these two time periods, type of the program is set to be TV play. With the program classification module, programs broadcast on the respective channels can be retrieved and classified regularly, so as to smartly update types of the programs on the respective channels. Program classification page may be a sub-page (i.e., secondary page), as shown in FIG. 6; taking a case that the type of TV play is selected as an example, a page showing a specific list of channels belonging to this type may be a third-level page, as shown in FIG. 7. Moreover, the touch-screen remote controller can display the same image as that displayed on the television.

It can be understood that, the above implementations are merely exemplary implementations used for explaining the principle of the present invention, but the present invention is not limited thereto. For those skilled in the art, various modifications and improvements may be made without departing from the spirit and essence of the present invention, and these modifications and improvements are also deemed as falling within the protection scope of the present invention.

1. A touch-screen remote controller, comprising a microprocessor module, a touch-control module, a power supply module, a storage module and a program classification module, wherein, the power supply module provides power for the microprocessor module, the touch-control module achieves a touch-control function under the control of the microprocessor module, the storage module stores TV listings therein and is connected with the microprocessor module, and the program classification module is used for classifying TV programs contained in the TV listings stored in the storage module under the control of the microprocessor module.

2. The touch-screen remote controller according to claim 1, wherein, the program classification module classifies programs broadcast on respective channels according to time period and program content.

3-16. (canceled)

17. The touch-screen remote controller according to claim 1, further comprising a program type selecting module used for selecting a program type to be displayed from program types classified by the program classification module, and a program selecting module used for selecting one channel from channels belonging to the program type selected by the program type selecting module to display a program of the one channel.

18. The touch-screen remote controller according to claim 2, further comprising a program type selecting module used for selecting a program type to be displayed from program types classified by the program classification module, and a program selecting module used for selecting one channel from channels belonging to the program type selected by the program type selecting module to display a program of the one channel.

19. The touch-screen remote controller according to claim 1, further comprising an eye tracking module which is respectively connected to the touch-control module and the microprocessor module and is used for determining position coordinates of a fixation point of a user's eyes on a touch screen and implementing selection commands by means of processing of the microprocessor module.

20. The touch-screen remote controller according to claim 2, further comprising an eye tracking module which is respectively connected to the touch-control module and the microprocessor module and is used for determining position coordinates of a fixation point of a user's eyes on a touch screen and implementing selection commands by means of processing of the microprocessor module.

21. The touch-screen remote controller according to claim 17, further comprising a charge management module which is connected with the power supply module and is used for charging the power supply module.

22. The touch-screen remote controller according to claim 21, wherein, a USB interface and/or a solar energy receiving module is provided on the charge management module, and the charge management module charges the power supply module via the USB interface, and/or charges the power supply module with solar energy through the solar energy receiving module.

23. The touch-screen remote controller according to claim 17, further comprising an infrared emitting module which is used for transmitting selection signals processed by the microprocessor module to a television to achieve display.

24. The touch-screen remote controller according to claim 17, further comprising an illumination module connected with the power supply module.

25. The touch-screen remote controller according to claim 17, wherein, a touch screen of the touch-screen remote controller is a liquid crystal screen.

26. The touch-screen remote controller according to claim 17, further comprising a remote controller power switch button connected to the microprocessor module, wherein
when a duration for which the remote controller power switch button is pressed is less than 2 seconds, the microprocessor module controls a touch screen of the touch-screen remote controller to be locked; and
when a duration for which the remote controller power switch button is pressed is no less than 2 seconds, the microprocessor module controls the power supply module of the touch-screen remote controller to be turned off or turned on.

27. The touch-screen remote controller according to claim 26, further comprising a reset button connected to the microprocessor module, wherein
when a television is in an off-state, by holding the reset button down and clicking the remote controller power switch button, the touch screen displays a calendar and/or temperature and/or humidity; and by holding the reset button down and double-clicking the remote controller power switch button, the touch screen displays an electronic album.

28. The touch-screen remote controller according to claim 17, wherein, the touch-screen remote controller is capable of displaying synchronously with a television based on a multi-screen interactive technique.

29. A remote control method using a touch-screen remote controller, wherein, the touch-screen remote controller is the touch-screen remote controller according to claim 1, and the remote control method using the touch-screen remote controller comprises the following step of:
classifying, by controlling the program classification module of the touch-screen remote controller through the microprocessor module, TV programs contained in the TV listings stored in the storage module.

30. The remote control method using a touch-screen remote controller according to claim 29, wherein, the step of classifying TV programs specifically comprises:
with respect to the TV listings stored in the storage module, classifying, by controlling the program classification module of the touch-screen remote controller through the microprocessor module, programs broadcast on respective channels according to time period and program content.

31. The remote control method using a touch-screen remote controller according to claim 29, wherein, the touch-screen remote controller further comprising a program type selecting module used for selecting a program type to be displayed from program types classified by the program classification module, and a program selecting module used for selecting one channel from channels belonging to the program type selected by the program type selecting module to display a program of the one channel, the remote control method using the touch-screen remote controller further comprising the following steps of:
a program type selecting step of selecting, by using the program type selecting module, a program type to be displayed from program types classified by the program classification module; and
a program selecting step of selecting, by using the program selecting module, one channel from channels belonging to the program type selected by the program type selecting module to display a program of the one channel.

32. The remote control method using a touch-screen remote controller according to claim 30, wherein, the touch-screen remote controller is the touch-screen remote controller further comprising a program type selecting module used for selecting a program type to be displayed from program types classified by the program classification module, and a program selecting module used for selecting one channel from channels belonging to the program type selected by the program type selecting module to display a program of the one channel, the remote control method using the touch-screen remote controller further comprising the following steps of:
a program type selecting step of selecting, by using the program type selecting module, a program type to be displayed from program types classified by the program classification module; and
a program selecting step of selecting, by using the program selecting module, one channel from channels belonging to the program type selected by the program type selecting module to display a program of the one channel.

33. The remote control method using a touch-screen remote controller according to claim 31, wherein, the touch-screen remote controller comprises an eye tracking module, the program type selecting step specifically comprises:
determining, by the eye tracking module, position coordinates of a fixation point of a user's eyes on a touch screen; and
controlling, by the microprocessor module, the program type selecting module to execute a command of selecting a program type, according to the position coordinates of the fixation point of the user's eyes on the touch screen;
the program selecting step specifically comprises:
determining, by the eye tracking module, position coordinates of a fixation point of the user's eyes on the touch screen; and
controlling, by the microprocessor module, the program selecting module to execute a command of selecting a channel, according to the position coordinates of the fixation point of the user's eyes on the touch screen.

34. The remote control method using a touch-screen remote controller according to claim 32, wherein, the touch-screen remote controller comprises an eye tracking module, the program type selecting step specifically comprises:
determining, by the eye tracking module, position coordinates of a fixation point of a user's eyes on a touch screen; and
controlling, by the microprocessor module, the program type selecting module to execute a command of selecting a program type, according to the position coordinates of the fixation point of the user's eyes on the touch screen;
the program selecting step specifically comprises:
determining, by the eye tracking module, position coordinates of a fixation point of the user's eyes on the touch screen; and
controlling, by the microprocessor module, the program selecting module to execute a command of selecting a channel, according to the position coordinates of the fixation point of the user's eyes on the touch screen.
